(19) United States
(12) Patent Application Publication
(10) Pub. No.: US 2011/0062641 A1
(43) Pub. Date: Mar. 17, 2011

(54) STAGE EQUIPPED WITH ALIGNMENT FUNCTION, PROCESSING APPARATUS HAVING THE STAGE EQUIPPED WITH ALIGNMENT FUNCTION, AND METHOD OF ALIGNING SUBSTRATE

(76) Inventors: Seiichi Sato, Kanagawa (JP); Mitsuru Yahagi, Kanagawa (JP); Hirofumi Minami, Kanagawa (JP); Kazuhiro Musha, Kanagawa (JP); Makoto Takahashi, Saitama (JP)

(21) Appl. No.: 12/991,993

(22) PCT Filed: Jun. 3, 2009
(86) PCT No.: PCT/JP2009/060118

§ 371 Date: Nov. 15, 2010

(30) Foreign Application Priority Data
Jun. 3, 2008 (JP) 2008-145585
Sep. 19, 2008 (JP) 2008-241474

(51) Int. Cl. B25B 11/00

(52) U.S. Cl. 269/21

(57) ABSTRACT

There is provided an inexpensive stage which is equipped with an alignment function and is capable of easily performing high-accuracy alignment especially in a θ direction even in case an object to be processed is large in weight. The stage equipped with an alignment function has a stage main body for holding a substrate while leaving a processing surface thereof open to access. The stage is provided with: a suction means capable of sucking that surface of the substrate which lies opposite to the processing surface; a gas supply means for supplying a gas to such a region of the substrate as is other than a portion sucked by the suction means; and a drive means to give a rotating force to the suction means so that the substrate can be rotated on the same plane by causing the suction means to serve as the center of rotation.

### TECHNICAL FIELD

The present invention relates to a stage equipped with an alignment function, a processing apparatus having the stage equipped with an alignment function, and a method of aligning a substrate. The invention relates, in particular, to those which are used in an inkjet type of coating apparatus provided with coating heads which are disposed in a manner to be movable along an axis.

### BACKGROUND ART

It is known to use an inkjet type of coating apparatus (hereinafter referred to as a “coating apparatus”) in order to directly form, on a substrate, electrically conductive fine patterns, and the like without going through a photolithography process. The apparatus is recently used in forming very fine source/drain electrode patterns of several μ mm in the step of manufacturing large-area thin film transistor substrates, and also in forming color filters, alignment layers and spacers for flat panel displays.

As this kind of coating apparatus, there is known one, in patent document 1, having the following arrangement. That is, the one described in patent document 1 is made up of: a stage which is capable of holding by sucking a substrate to be processed while leaving the surface to be processed open to access; and an inkjet means. The stage is movable along an X-axis guide by means of a feed screw having a motor. On the other hand, the inkjet means has: a portal supporting means which is disposed on a path of movement of the stage so as to bridge the stage; and at least one coating head for coating the substrate with a predetermined ink, the coating head being disposed on the supporting means so as to be movable in a Y-axis direction.

It is to be noted here that the above-mentioned coating apparatus has a possibility of positional deviation when the substrate is held by suction onto the stage or when the substrate is placed in position on the stage by a transfer robot. As a solution, prior to the coating of the ink, there is performed positioning (alignment) of the scanning surface of the substrate relative to the coating head. At this time, it is necessary to adjust the inclination of the substrate not only in the X-axis direction and Y-axis direction, but also in a θ direction by rotating the substrate on the same plane.

In this case, it is conceivable to arrange such that the alignment is performed by rotating the stage itself in a state in which the substrate is held sucked. However, in case the large-area substrate for use as a flat panel display as described above is the object to be processed, not only does the substrate weight increase accompanied by the increase in the substrate size, but also does the stage itself increase in size, and the weight thereof increases depending on the substrate size. Therefore, in the above-mentioned method, there will become needed a rotating mechanism (bearings and the like) so as to rotate the total weight of the substrate and a transfer table. As a result, the apparatus itself will necessarily have to be large in size. In addition, in order to align the stage at a high accuracy by rotating the stage, there will be needed a motor which is of high thrust force and high-performance, thereby resulting in a disadvantage of a higher cost.

On the other hand, it is conceivable to arrange, in stead of arranging the stage in a rotatable manner, the supporting means to support the coating heads to be rotatable so as to perform the alignment in the θ direction. This idea has, however, a disadvantage in that the transfer table must also be moved in the X-axis direction and in the Y-axis direction depending on necessity while rotating the supporting means at the time of alignment in the θ direction. The control to perform high-accuracy alignment will be remarkably complicated.

### Patent Document 1: JP-A-2006-136770

### DISCLOSURE OF THE INVENTION

### Problems to be Solved by the Invention

In view of the above-mentioned problems, this invention has a problem of providing: a stage equipped with an alignment function which is capable of performing alignment especially in the θ direction at high accuracy and with ease even in case the weight of the object to be processed is large; a processing apparatus having the stage equipped with the alignment function; and a method of aligning a substrate.

### Means of Solving the Problems

In order to solve the above problems, the invention according to claim 1 is a stage equipped with an alignment function, the stage having a stage main body for holding an object to be processed while leaving a processing surface thereof open to access. The stage comprises: a suction means capable of sucking an opposite surface of the object to be processed, the opposite surface lying counter to the processing surface; a gas supply means for supplying a gas to such a region of the object to be processed as is other than a portion sucked by the suction means; and a drive means for rotatably driving the suction means so as to rotate the object to be processed on the same plane by causing the suction means to serve as a center of rotation.

According to this invention, the object to be processed is placed in position on the stage while leaving the processing surface of the object to be processed open to access. The suction means is caused to suck an opposite surface of the object to be processed, the opposite surface lying counter to the processing surface. Then, the gas is supplied to such a region of the object to be processed as is other than a portion sucked by the suction means. In this state, the suction means is rotated by the drive means on the same plane by causing the suction means to serve as the center of rotation. Then, the object to be processed can be rotated by a predetermined angle integrally with the suction means. As a result, the substrate (object to be processed) can be rotated in the θ direction so as to perform the alignment.

As described above, this invention has employed an arrangement in which, by supplying the gas to the portion other than the region that is sucked by the suction means, the alignment in the θ direction is performed by rotating, integrally with the suction means, only the object to be processed in a state in which the portion other than the region sucked by the suction means is kept levitated or floated (in this case, it is sufficient if the frictional resistance is reduced at least between the portion in question and the upper surface of the stage). Therefore, even in case where, e.g., the object to be processed is large in weight, there is no need of a rotary mechanism such as a large-sized bearing, and the like. The apparatus can thus be prevented from getting large in size. In addition, since the object to be processed can be rotated with a small thrust force, a high-precision alignment can be performed without employing a high-performance motor, thereby contributing to the cost reduction. Still furthermore, the alignment in the θ direction can be performed without moving the processing means such as an inkjet means that is disposed so as to lie opposite to the objet to be processed held by the stage, thereby making it easy to control the alignment

Further, in order to solve the above problems, the invention according to claim 2 is a stage equipped with an alignment function. The stage has a holding tray for holding thereon an object to be processed while leaving a processing surface thereof open to access, and a stage main body for supporting the holding tray in a rotatable manner. The stage comprises: a gas supply means for supplying a gas to an opposite surface of the holding tray, the opposite surface lying counter to the processing surface; and a drive means for rotatably driving the holding tray so as to rotate the holding tray on a same plane.

This invention has employed an arrangement in which the substrate (object to be processed) is aligned in the θ direction by rotating with the drive means integrally with the suction means, the object to be processed in a state of being held on the tray while the tray is kept levitated (in a manner similar to the above case, it is sufficient if the frictional resistance is reduced at least between the holding tray and the upper surface of the stage). Therefore, like in the above case, there is no need of a rotary mechanism such as a large-sized bearing, and the like, thereby contributing to the lower cost.

The stage according to this invention preferably further comprises a guide means, and a moving means for moving the stage main body along the guide means. Then, the alignment in the direction of moving the stage main body can be performed only by changing the stopping position of the stage main body relative to the processing means such as a coating head which is disposed on an upper part of the guide means.

Further, the stage according to this invention preferably further comprises: a suction groove formed along a surface of contact of the stage main body or the holding tray with the object to be processed; and a vacuum pump for evacuating the suction groove in a state in which the object to be processed is mounted on the stage or the holding tray. Then, for example, when the stage main body is moved along the guide means, the object to be processed can advantageously be surely held by the stage main body or the holding tray.

In case the alignment in the θ direction is performed on the above-mentioned stage, not only is required the positioning accuracy (e.g., below 1μ radian), but also is strongly required the reduction in alignment time. In this case, preferably, the drive means comprises: a fine-adjustment mechanism for rotating the suction means within a predetermined micro-angle range; and a coarse-adjustment mechanism for rotating the suction means within an angle range larger than the angle range of the fine-adjustment mechanism. According to this arrangement, after driving the object to be processed, by the coarse-adjustment mechanism, at a high speed to the neighborhood of a target position, a high-precision positioning can thereafter be performed by the fine-adjustment mechanism. As a result, high-accuracy alignment can be materialized at a short time.

Preferably, the coarse-adjustment mechanism is coupled to the suction means. The fine-adjustment mechanism comprises an arm and a drive source for swinging the arm. The fine-adjustment mechanism and the coarse-adjustment mechanism are operatively coupled to each other such that, when the arm is swung by the drive source, the suction means is rotatably driven through the coarse-adjustment mechanism. Then, the rotary shaft to rotatably drive the suction means can be made in common with each other, thereby eliminating the complex structure of the drive means. In addition, at the time of performing alignment in the θ direction, switching can be made smoothly from the rotatable driving with the coarse-adjustment mechanism to the rotatable driving with the fine-adjustment mechanism.

Further, the arm of the fine-adjustment mechanism has a length to be extended at least to one side of the stage main body and is connected at a front end of the arm to the drive source. Then, the amount of displacement of the front end of the arm required for movement by a predetermined micro-angle range will become large. As a result, the resolution of the detection means such as an encoder to detect the amount of displacement can be improved to thereby materialize a higher precision alignment.

In order to solve the above problems, a processing apparatus according to this invention comprises: the stage equipped with an alignment function according to any one of claims 1 through 7; and a processing means for performing a predetermined processing on the object to be processed, the processing means being disposed to lie opposite to the object to be processed that is held by the stage.

In order to solve the above problems, the method of aligning a substrate (an object to be processed) comprises the steps of: mounting on a stage a substrate (the object) to be processed in a manner to leave a processing surface thereof open to access; causing a suction means to suck an opposite surface of the substrate (object to be processed), the opposite surface lying counter to the processing surface, the sucking means being disposed on the stage; supplying a gas to the opposite surface except for a region that is sucked by the suction means; and aligning the object to be processed by rotating the substrate (object to be processed) by a predetermined angle on the same plane by causing the suction means to serve as a center of rotation.

In this case, the step of aligning the object to be processed preferably comprises: rotating the suction means by a range of angle which is larger than a predetermined micro-angle range; and thereafter further rotating the suction means within the micro-angle range.

### BEST MODE FOR CARRYING OUT THE INVENTION

With reference to the drawings, description will now be made of an example in which a substrate S made of glass and the like for directly forming thereon electrically conductive fine patterns and the like is defined as an object to be processed, and in which a stage equipped with an alignment function and for holding the substrate S according to an embodiment of this invention is applied to an inkjet type of coating apparatus.

The inkjet apparatus has a platform 1, and on this platform 1 is disposed a base plate 2 which is rectangular parallelepiped in shape. The base plate 2 is made of granite and the like so as to secure smoothness on the top surface thereof. The top surface of the base plate 2 is provided with a pair of right and left rail members (guide means) 3R, 3L which are extended horizontally in the axial direction over the entire length of the base plate 2 (see FIG. 2).

On the rail members 3R, 3L, a stage 4 which is equipped with an alignment function is disposed in a manner to be reciprocated, i.e., movable back and forth. The stage 4 has a stage main body 4a of a plate shape. On the bottom four corners of the stage main body 4a, there are mounted sliders (sliding members) 5 which are slidably engaged with the relevant rail members 3R, 3L. On the bottom surface of the stage main body 4a, there are also disposed nut members (not illustrated). Each of the nut members is engaged in a threaded manner with a feed screw (not illustrated) which is disposed along the two rail members 3R, 3L within a range of extension of the rail members 3R, 3L. When a motor (not illustrated) coupled to one end of the feed screw is rotated, the stage 4 is moved back and forth along the rail members 3R, 3L (hereinafter, the direction of this back-and-forth movement is referred to as an X-axis direction). In this arrangement, the above-mentioned feed screw and the motor constitute a moving means in this embodiment. The moving means is not limited to the above example; for example, there may be used a linear motor which is made up of a moving part and a stator of a magnetic levitation system.

At a position in which the stage main body 4a is located at one side as seen in the X-axis direction of the rail members 3R, 3L (right-hand position in FIG. 1, i.e., a transfer position), it is so arranged that the transfer of the substrate S to the stage main body 4a is performed by an articulated transfer robot R of a known structure. For the purpose of transfer of this substrate S, there are provided: a lifting means 6 made up of a plurality of supporting rods 6a which are disposed vertically so as to penetrate through the base plate 2 in the vertical direction of the base plate 2; and air cylinders (not illustrated) for moving up and down the respective supporting rods 6a. It is thus so arranged that the substrate S can be supported at a predetermined elevated position above the upper surface of the stage main body 4a (see FIG. 1).

On the other hand, at a position in which the stage 4 is located on the other side of the rail members 3R, 3L as seen in the X-axis direction (left-hand position in FIG. 1, i.e., a processing position), it is so arranged that a predetermined processing is performed while appropriately moving back and forth the stage main body 4a in the X-axis direction. In the inkjet type of coating apparatus according to this embodiment, an inkjet means 7 as the processing means is positioned substantially in the middle portion of the rail members 3R, 3L. The inkjet means 7 is made up of: a portal supporting member 7 which is disposed in a manner to bridge the stage main body 4a in a direction at right angles to the X-axis direction; and a plurality of coating heads 7b for coating the substrate S, held in position on the stage main body 4a, with the ink.

Each of the coating heads 7b is held by a holder 7d so that the front ends of the nozzles 7c are positioned on the same horizontal plane and at an equal distance from one another. The holder 7d is mounted on the upper horizontal portion of the supporting member 7a in such a manner that the coating heads 7b lie on the side of the processing position (left side in FIG. 1). In this case, the holder 7d is engaged in a screwed manner with a motorized feed screw (not illustrated) which is housed inside the upper horizontal portion of the supporting means 7a. When the motor is driven to rotate the feed screw, each of the coating heads 3 is integrally moved back and forth in a direction at right angles to the X-axis direction (the direction of this back-and-forth movement is hereinafter referred to as a Y-axis direction).

Each of the coating heads 7b has a known structure, i.e., by appropriately driving a piezoelectric element disposed in an ink chamber, the ink contained in an ink tank 5 is caused to drop. The ink contained in the ink tank 5 is appropriately selected depending on what is going to be formed on the surface of the substrate S. For example, if the product is for forming a spacer for use in a flat panel display, there will be used an ink which is made from the spacer particles, binder, and solvent.

When the substrate S is handed over to the stage main body 4a by the transfer robot R as described above, there are cases where the substrate S gives rise to positional deviation relative to the stage main body 4a. Therefore, it is necessary to perform the positioning (alignment) of the substrate S relative to the coating heads 7b prior to the coating of the ink. At this time, not only the adjustment in the X-axis direction and the Y-axis direction, but also the adjustment of the inclination (inclination angle θ) of the substrate S relative to each of the coating heads 7b must also be made by rotating the substrate S on the same plane (the direction of this rotation is hereinafter referred to as θ direction, see FIG. 2).

The stage 4 according to the first embodiment has: a suction means 8 which is capable of sucking a central region on the rear surface of the substrate S; a gas supply means 9 for supplying a gas to such a region of the substrate S as is other than a portion sucked by the suction means 8; and a drive means 10 for giving a rotating force to the suction means 8 so that the substrate S can be rotated in the θ direction on the same plane by causing the suction means 8 to serve as the center of rotation, i.e., so that the suction means 8 can be rotatably driven (see FIG. 3).

The suction means 8 has a chuck plate 11 housed in a recessed portion 4b which is provided in the center of the stage main body 4a and which is rectangular in shape as seen in plan view. The chuck plate 11 is made, e.g., of a suction pad of known structure or of a disk of porous structure, and is connected to a vacuum pump through an evacuation pipe (not illustrated). When the vacuum pump is operated, the chuck plate 11 is arranged to suck, by an entire front surface thereof, the rear surface of the substrate S. Further, in the center on the rear side of the stage main body 4a, there is concentrically formed a through hole 4c which is in communication with the recessed portion 4b. The through hole 4c is provided with a sleeve member 12 and a ball bearing 13 so that a push member 14 can be supported by the ball baring 13. In this case, the push member 14 and an inner race 13a of the ball bearing 13 are connected together by means, e.g., of a key connection using a parallel key or a spline connection (see FIG. 4).

The push member 14 is coupled to a drive rod 15a of a direct acting type of actuator 15 of a known structure, disposed below the push member 14. Depending on the size of the substrate, an air cylinder may be used in place of the direct acting actuator. In such a case, there may be employed an arrangement in which the air cylinder is operated by making use of the gas to be supplied by the gas supply means 9, thereby simplifying the apparatus. When the actuator 15 is operated, the chuck plate 11 is movable between an elevated position in which the upper surface of the chuck plate 11 projects upwards beyond the upper surface of the stage main body 4a, and a lowered position in which the upper surface of the chuck plate 11 is at least flush with the upper surface of the stage main body. In addition, when the inner race 13a is given a rotating force by an arm which is described hereinafter, the push member 14 is rotatably driven. The chuck plate 11 and consequently the substrate S are rotated in the 0 direction by causing the push member 14, which works as the rotary axis of the suction means 8, to serve as the center of rotation.

The gas supply means 9 is made up of; a plurality of recessed grooves 16 which are formed in the X-axis direction substantially along the entire length of the upper surface of the stage main body 4a; air pads 17 which are each disposed in respective recessed grooves 16 at a predetermined distance from one another; and a gas pipe 18 which supplies each of the air pads 17 with gas such as compressed air from a compressor and the like (not illustrated) (see FIGS. 2 and 4). In this case, the number of the recessed grooves 16 to be formed, and the number of air pads 17 to be disposed are appropriately set depending on the weight of the substrate S to be supported by the stage main body 4a.

The drive means 10 is provided with a plate-shaped arm 19. One end of the arm 19 is coupled by a pin to the inner race 13a in the center line of the arm 19. The other end of the arm 19 is extended to the side surface of the stage main body and is connected to the drive source 20 disposed on the side surface thereof. The drive source 20 has a frame 20a, and a feed screw 20b with a motor M is disposed inside the frame 20a in the X-axis direction. The feed screw 20b has engaged therewith in a screwed manner a movable member 20c having formed therein a screwed hole. On an upper part of the movable member 20c, there is engaged a slider part 20d in a manner to be slidable along a rail member 20e which is attached to the feed screw 20b on the upper inside of the frame 20c. According to this arrangement, when the motor M is operated to rotate the feed screw 20b, the movable member 20c is movable back and forth in the X-axis direction depending on the direction of rotation of the motor M (see FIGS. 2 and 5).

On the lower surface of the movable member 20c, there is formed a rail part 20f which is extended in the Y⁻axis direction. The rail part 20f has engaged therewith a supporting member 20g in a slidable manner. To the lower end of the supporting member 20g, there is coupled the other end of the arm 19 through a bearing 20h. When the feed screw 20b is rotated to move the movable member 20c along the rail member 20e, a rotating force is given to the push member 14 which serves as the rotary shaft of the suction means 8, while the supporting member 20g moves along the rail part 20f.

In this case, there is constituted a fine⁻adjustment mechanism which swings the arm 19 within a range of stroke of the back and forth movement of the movable member 20c to thereby rotatably drive the push member 14, and consequently the suction means 9 by a predetermined micro-angle range (e.g., within 1 degree) (hereinafter, this fine-adjustment mechanism as the drive means is denoted by a reference numeral 10). The micro-angle range of this invention can be appropriately set depending on the precision and the like which is required at the time of aligning the substrate S. By changing the stroke of the back-and-forth movement of the movable member 20c, the micro-angle range can be adjusted. Further, the drive source 20 is provided with a detection means such as a photoelectric linear encoder (not illustrated) so that the amount of displacement of the movable member 20c can be detected. According to this arrangement, the amount of displacement of the movable member 20c when the arm 19 is moved by a micro-angle amount (e.g., by 1 degree) becomes larger than the amount in the case in which detection is made of the amount of rotary deviation by providing the push member 14 with detection means such as a rotary encoder and the like. As a result, the precision of the detection means which detects the amount of deviation can be increased, whereby a more precise alignment can be materialized.

When, e.g., the stage main body 4a is moved from the hand-over position to the processing position, if the substrate S is held by suction with the suction means 8 alone, there will occur a disadvantage in that, e.g., the substrate S will be detached off from the suction means 8 at the time of starting of, or stopping of, the movement of the stage main body 4a. As a solution, the stage main body 4a has formed on an upper surface thereof a plurality of suction grooves 21 which are communicated with the vacuum pump, the suction grooves being formed in a manner to be extended in the X-axis direction and Y-axis direction (see FIG. 2). When the stage main body 4a is moved, the suction grooves 21 are evacuated. In this manner, the substrate S is arranged to be held by suction substantially over the entire surface of the substrate S.

A description will now be made of the alignment of the substrate S by means of the stage 4 equipped with an alignment function according to this invention. At the hand-over position of the stage main body 4a, each of the supporting rods 6a of the lifting means 6 is lifted. Thereafter, the substrate S is transferred by the transfer robot R and is disposed in position so that the substrate S can be supported by a front end of each of the supporting rods 6a (see FIG. 1). Then, each of the supporting rods 6a is lowered to thereby place the substrate S on the stage main body 4a. The substrate S on which the ink is coated is provided with at least one mark R (about several tens microns through 0.1 mm in size) of a predetermined shape at a position which serves as an origin of the scanning surface at the time of ink coating (see FIG. 2).

Once the substrate S has been placed on the stage main body 4a, the suction grooves 21 are evacuated to thereby cause the substrate S to get sucked to the stage main body 4a substantially over the entire surface of the stage main body. In this state, a feed screw (not illustrated) is rotated to move the stage main body 4a to the processing position. When the stage main body 4a has reached the processing position, the substrate S is pictured by a picturing means such as a CCD camera and the like mounted on the supporting member 7a of the inkjet means 7. The pictured image is analyzed by an image analyzing means of a known structure. The analyzed data is outputted to a control means (not illustrated) such as a microcomputer and the like which controls the operation of the inkjet type of coating apparatus. When the data is inputted into the control means, there is calculated an amount of displacement (correction value) in the direction of the X-axis direction, the Y-axis direction and the θ direction for the purpose of aligning the substrate position by causing the mark R on the substrate S to serve as a reference (or standard). When the correction value is calculated, control is made of the motor for the feed screw which moves the stage main body 4 and of the motor for moving the holder 7d of the inkjet means. Alignment is thus made first of all relative to the coating heads 7a in the X-axis direction and in the Y-axis direction. Then, the vacuum pump is stopped in operation and the suction of the substrate S is released.

Subsequently, when the actuator 15 is operated to lift the chuck plate 11, the substrate is lifted off from the upper surface of the stage main body 4a. At this time, the vacuum pump which is in communication with the chuck plate 11 and the gas supply means 9 are operated. As a result, the substrate S is sucked at points of contact between the chuck plate 11 and the substrate S. At the same time, due to the gas to be ejected from each of the air pads 18 of the gas supply means 9, the portion excluding the region which is sucked by the chuck plate 11 (i.e., peripheral portion of the substrate) is caused to be levitated. In this manner, when the central portion of the substrate S is held sucked and the periphery thereof is levitated, the motor M of the fine-adjustment mechanism 10 is driven to thereby appropriately rotate the feed screw depending on the correction value calculated by the control means. According to this arrangement, the rotating force is given to the chuck plate 11 through the arm 19 which swings about the actuator 15 as the center and through the push member 14. Only the substrate S is rotated relative to the upper surface of the stage main body 4a by a predetermined micro-angle range in the θ direction depending on the above-mentioned correction value, whereby an alignment in the θ direction can be performed (see FIG. 6).

Without lifting the chuck plate 11, the gas may be supplied at the lowered position of the chuck plate 11 from the gas supply means 9. Even in a state in which the portion except for the region that is sucked by the chuck plate is not levitated in a strict sense of the term, alignment in the θ direction can still be performed in a state in which the frictional resistance between the portion in question and the upper surface of the stage main body 4a is substantially reduced. For example, in case the substrate has a deflection, this solution is advantageous for accurate alignment.

The lifting of the substrate S can be confirmed: e.g., by a change in flow amount of an air flow sensor connected to the gas pipe 18 in communication with each of the air pads 18; or by the detection of the change in height as a result of direct scanning of the substrate surface by using a laser displacement meter and the like from the upper surface of the substrate. Then, by performing alignment in the θ direction upon confirmation of levitation, the rear surface of the substrate S can be prevented from getting into contact with the stage main body 4a. Alignment can thus be performed without damaging the rear surface of the substrate S. Alternatively, by rotating the substrate S in a lowered position of the chuck plate 11, the layer of the air to be supplied from the gas supply means 9 can prevent the rear surface of the substrate S from getting damaged.

In this manner, according to the embodiment of this invention, there has been employed an arrangement in which the alignment in the θ direction can be performed by rotating only the substrate S: in a state in which the portion except for the sucked region is kept levitated by the gas to be ejected from the air pads 18; or in a state in which the frictional resistance is substantially reduced between the portion at least exclusive of the sucked region and the upper surface of the stage main body 4a. Therefore, even in case the weight of the substrate S is large, there is no need of a rotary mechanism such as a large bearing and the like, whereby the apparatus itself can be prevented from getting large in size. In addition, since the substrate S can be rotated with a small thrust force, a high-precision alignment becomes possible without using a high-performance motor, thereby contributing to the reduction in cost. Furthermore, while alignment in the θ direction is being performed, the inkjet means 7 and consequently the position of the coating heads 7b need not be moved. There is thus no need of a special control at the time of alignment of the substrate.

After the above-mentioned alignment has been finished, confirmation is made as to whether the substrate S has been moved in the X-axis direction, in the Y-axis direction, and in the θ direction in response to the amount of displacement (correction value) that was calculated to align the substrate position. In other words, the operation of the gas supply means 9 is stopped and also the actuator 15 is operated to lower the chuck plate 11, and the operation of the vacuum pump in communication with the chuck plate 11 is stopped. Then, the suction grooves 21 are evacuated and the substrate S is sucked to the stage main body 4a substantially over the entire surface thereof. In this state, the substrate S is pictured in the same manner as noted above by a picturing means such as a CCD camera and the like. The pictured image is analyzed by the image analyzing means, and the analyzed data is outputted to the control means. In this manner, the above-mentioned confirmation is made by causing the mark R of the substrate S to serve as a reference.

By so arranging that confirmation is made in a state in which the substrate S is kept sucked to the stage main body 4a after completion of the alignment as described above, the above-mentioned confirmation can be made without being influenced by the positional deviation that may occur between the case in which the substrate S is on the stage main body 4a and the case in which the substrate S is levitated.

Subsequently, once the confirmation of alignment of the substrate S in the X-axis direction, in the Y-axis direction and in the θ direction has been finished, back-and-forth movements are appropriately made of the stage 4 in the X-axis direction and each of the coating heads 7a integrally in the Y-axis direction. During the above movements, each of the coating heads 7b is moved along the scanning surface of the substrate so that the substrate S is coated with ink in a pattern determined in advance. At this time, coating of the ink can be made in a state in which the center of the substrate S is lifted and that the peripheral portion of the substrate S is kept levitated by the gas to be ejected from the air pads 18. On the other hand, ink coating may alternatively be made in a state in which the substrate S is placed on the stage main body 4a once again, and in which the suction grooves 21 are evacuated so that the substrate S can be kept sucked substantially over the entire surface of the stage main body 4a.

In the above-mentioned embodiment, a description has been made of an example in which the substrate S is levitated only by the gas to be ejected out of the air pads 18. Alternatively, there may be employed the following arrangement, i.e., in order to stably levitate the substrate, the substrate S is levitated by keeping an equilibrium in balance between the evacuation of the suction grooves 21 and the pressure of the gas to be ejected out of the air pads 18. In addition, as the air pads 18, those which are arranged to enable both the gas ejection and evacuation at the same time may also be employed.

Further, in the above-mentioned embodiment, a description was made of an example in which an arrangement was made to rotate only the substrate S in the θ direction. It may also be so arranged that the stage main body is provided with a rotatable holding tray which holds the substrate S with the processing surface thereof left open to access.

In concrete, with reference to FIGS. 7 through 9, a description will now be made of such an example. A stage 30 with an alignment function relating to the first modified example is disposed on the pair of the left and right rail members 3R, 3L provided on the upper surface of the base plate 2, in the same manner as above, so as to be movable back and forth. The stage 30 has a stage main body 31 of plate shape. On the four corners of the lower surface of the stage main body 31, there are provided sliders 32 which are slidably engaged with the rail members 3R, 3L. In the same manner as above, the stage main body 31 is movable back and forth by rotation of a feed screw (not illustrated) along the two rail members 3R, 3L.

The stage main body 31 is provided, in a rotatable manner, with a plate-shaped holding tray 33 which is capable of holding the substrate S by suction. On the rear surface of the holding tray 33, there is formed a recessed space 33b of a dented shape at a plurality of positions so that there can be respectively formed therein a rib part 33a which maintains the strength of the holding tray 33 and, at the same time, guarantees the surface smoothness. On the rear central part of the holding tray 33, there is formed a rotary shaft 33c. The rotary shaft 33c is supported by a ball bearing 35 which is disposed, through a sleeve member 34, into a through hole formed in the center of the stage main body 31. In this case, similar to the above example, the rotary shaft 33c and the inner race 35a of the ball bearing 35 are of a key connection using a parallel key or a spline connection. In a non-operating state of the gas supply means, which is described in detail hereinafter, the lower surface of the rib part 33a is in surface contact with the upper surface of the stage main body 31 (see FIG. 7).

The stage main body 31 is provided with: a gas supply means 36 which supplies the recessed space 33 of the holding tray 33 with a gas; and a fine-adjustment mechanism 37 which rotatably drives the holding tray 33 so that the holding tray 33, that keeps holding the substrate S, can rotate on the same plane.

The gas supply means 36 is constituted by: recessed holes 36a which are each circular as seen in plan view and which are formed in a predetermined position on the upper surface of the stage main body 31; an air pad 36b which is porous in structure and which is housed inside each of the recessed holes 36a; and a gas pipe 36c which supplies each of the air pads 36c with a gas such as compressed air (see FIG. 7).

The fine-adjustment mechanism 37 which serves as a drive means is provided with a frame 37a mounted on one side surface of the stage main body 31. The frame 37a is provided with a feed screw 37b with a motor M, so as to be extended in the X-axis direction. The feed screw 37b gets engaged in a screwed manner with a movable member 37c having formed therein a screwed hole. At the lower part of the movable member 37c, there is formed a slider 37d. The slider part 37d is slidably engaged with a rail member 37e which is mounted in parallel with the feed screw 37b on the bottom inner side of the frame 37a. According to this arrangement, when the motor M is operated to thereby rotate the feed screw 37b, the movable member 37c becomes reciprocally movable in the X-axis direction depending on the direction of rotation of the motor M (see FIG. 8).

Further, on an upper surface of the movable member 37c, there is formed a rail part 37f which is extended in the Y⁻axis direction. The rail part 37f has slidably engaged therewith a supporting member 37g. On an upper end of the supporting member 37g, there is attached an arm 37i through a bearing 37h. The arm 37i is coupled to a side surface of the holding tray 33. When the feed screw 37b is rotated to thereby move the movable member 37c along the rail member 37e, the supporting member 37g moves along the rail part 37f, and the holding tray 33 is given a rotating force, thereby being rotatably driven. In this case, the arm 37i is swung within a range of the stroke of the reciprocating movement of the movable member 37c, whereby the holding tray 33 is rotatably driven within a predetermined micro-angle range (e.g., within one degree). In addition, between the supporting member 37g and the arm 37i, there may be interposed, in addition to the bearing 37h, a spring guide 37j which allows an up and down movement of the arm 37i relative to the supporting member 37g.

There is employed an arrangement in which: on an upper surface of the holding tray 33, there are appropriately formed suction grooves 38 in a manner to be extended in the X-axis direction and in the Y-axis direction, the suction grooves 38 being in communication with a vacuum pump; and by evacuating the suction grooves 38 the substrate S can be sucked and held substantially over the entire surface thereof (see FIG. 9).

In case alignment is performed in the θ direction, each of the air pads 36b of the gas supply means 36 is supplied with gas such as compressed air in a state in which the substrate S is held sucked substantially over the entire surface thereof. According to this arrangement, there can be attained a state in which the holding tray 33 is kept levitated off from the upper surface of the stage main body 31 or a state in which the frictional resistance between the two has substantially been reduced due to the compressed air. At this time, since the holding tray 33 is levitated, there will give rise to a deviation (clearance) in the direction of height, between the fine-adjustment mechanism 37 coupled to the stage main body 31 and the holding tray 33. However, the spline guide 37i will resolve the mechanical contradiction, i.e., the deviation can be absorbed.

Subsequently, the motor M of the fine-adjustment mechanism 37 is driven and, in the same manner as above, the feed screw 37b is appropriately rotated depending on the correction value calculated by the control means. According to this arrangement, the holding tray 33 is rotatably driven through the arm 37i, and the holding tray 33 that is holding the substrate S by suction will be rotated by a predetermined angle in the θ direction relative to the upper surface of the stage main body 31 by causing the rotation axis 33c to serve as the center of rotation.

As described above, according to the above-mentioned first modified example, there has been employed an arrangement in which the holding tray 33 that holds the substrate S is rotated. As a result of combined effects in: that the holding tray 33 is made lighter in weight by forming recessed space 33b on the rear surface of the holding tray 33; and that the portion of the substrate except for the part coupled to the rotary shaft 33c is kept levitated by supplying gas from the air pads 36b, there is no need of a rotary mechanism such as a large-size bearing, and the like. The apparatus itself can thus be prevented from getting large in size. Since the substrate S can be rotated at a small thrust force, high-precision alignment becomes possible without using a high-performance motor.

In the above-mentioned first modified example, a description has been made of an example in which the substrate S or the holding tray 33 that holds thereon the substrate S is rotated in the θ direction. However, there may be employed an arrangement in which the stage itself has further assembled thereto a drive apparatus provided, e.g., with a feed screw having a motor so as to be movable in the X-axis direction and in the Y-axis direction, whereby alignment in such directions can be performed.

Further, in the above-mentioned first modified example, a description has been made of an example in which the drive means is made up of the fine-adjustment mechanism 10. However, the drive mechanism need not be limited thereto. In order to coat the substrate S with the predetermined ink while moving the substrate S, e.g., in the θ direction, the drive mechanism may be arranged by a coarse-adjustment mechanism which is capable of rotating the suction means 8 by an angle range larger than that of the fine-adjustment mechanism and which, depending on cases, is capable of rotating the substrate S by 90 degrees or 180 degrees. As a second modified example provided with such a coarse-adjustment mechanism, the coarse-adjustment mechanism 100 is made up, as shown in FIG. 10, of a worm wheel 101 which is mounted on a drive rod 15a of the actuator 15 and which is connected to an inner race 13a of the ball bearing 13; and a worm 102 which is supported by a housing fixed to a frame (not illustrated) and which is rotatably driven by a motor (not illustrated). The coarse-adjustment mechanism 100 need not be limited to the above, and alternatively other known arrangement such as a DD motor and the like may be employed.

On the other hand, as a third modified example, the drive means may be constituted, as shown in FIGS. 11 and 12, of; the fine-adjustment mechanism 10 which is provided with the arm 19 and the drive source 20; and the coarse-adjustment mechanism 100 which is provided with the worm wheel 101 and the worm 102. In this case, the worm wheel 101 of the coarse-adjustment mechanism 100 is coupled to the inner race 13a, and one end of the arm 19 is fixed to the lower surface of the housing 103 which supports the worm 102 to be engaged with the worm wheel 101.

In the above-mentioned drive means, when the worm 102 of the coarse-adjustment mechanism 100 is rotatably driven by a motor M disposed on the housing 103, the worm wheel 101 is rotated and, as a result of rotation of the inner race 13a that is coupled to the worm wheel 101, the push member 14 is rotated. Then, the chuck plate 11 is rotated and the substrate S is rotated in the θ direction within an angle range larger than that of the fine-adjustment mechanism 10. At this time, there is no rotating force transmitted to the arm 19. Then, when the drive source 20 is driven (see FIGS. 1 and 2), the arm 19 will be swung by causing the actuator 15 to serve as the center of swinging or rotating movement. At this time, the worm 102 will be swung together with the housing 103 that is fixed to the arm 19. As a result of rotation of the worm wheel 101 accompanied by the above, the push member 14 and the chuck plate 11 are rotated, and the substrate S will be rotated in the θ direction by a predetermined micro-angle.

According to the above-mentioned arrangement, since the suction means 8 is rotatably driven, the rotating force can be given to the push member 14 which serves as a common rotary shaft, from the fine-adjustment mechanism 10 and the coarse-adjustment mechanism 100. As a result, the rotary shaft (push member 14) to rotatably drive the suction means 8 can be arranged in common with each other and, consequently, the drive means can be prevented from getting complicated in its structure. Further, at the time of performing alignment in the θ direction, switching from the rotatable driving by the coarse-adjustment mechanism 100 to the rotatable driving by the fine-adjustment mechanism 10 can also be made smooth.

In addition, at the time of picturing the substrate S by, e.g., a picturing means, in order to calculate the amount of displacement (correction value) in the θ direction so that the position of the substrate S is aligned with that mark R on the substrate S which serves as a standard or reference, there may be the following case, i.e., a case in which the mark R deviates beyond the picturing range of the picturing means, or a case in which the calculated correction value exceeds the micro-angle range that can be aligned by the fine-adjustment mechanism. In such a case, first, the substrate S is rotatably driven by means of the coarse-adjustment mechanism 100 at a high speed to the neighborhood of a target position (i.e., to an angle range that is capable of aligning by the fine⁻adjustment mechanism 10). Depending on the necessity, the substrate S is pictured again by the picturing means to thereby calculate the correction value by causing the mark R of the substrate S to serve as a standard. Subsequently, by means of the fine-adjustment mechanism 10, high-accuracy positioning can be performed. According to this arrangement, highly accurate and short-time alignment can be materialized.

In the above-mentioned third modified example in which the drive means has the fine-adjustment mechanism 10 and the coarse-adjustment mechanism 100, it is so arranged that the rotating force from each of the fine-adjustment mechanism 10 and the coarse-adjustment mechanism 100 is inputted into the push member 14. It is however not limited thereto. As a fourth modified example, the following arrangement may be employed. In other words, as shown in FIG. 13, in a manner coaxial with the push member 14, another hollow rotary shaft 201 is disposed through a bearing 201a for fine-adjustment driving. The lower surface of this hollow rotary shaft 201 may be connected to the upper surface of a housing 202 which houses therein the worm wheel 101 and the worm 102. According to this arrangement, when the worm 102 of the coarse-adjustment mechanism 100 is rotatably driven, the push member 14 is rotated without transmitting the rotating force to the arm 19. When the drive source 20 is driven, on the other hand, the arm 19 is swung by causing the actuator 15 to serve as the center of swinging or rotating movement, the hollow rotary shaft 201 coupled to the arm 19 through the housing 202 is rotated and, accompanied by this, the push member 14 is rotated through the worm wheel 101.

Although not illustrated, as still another modified example, an arrangement may be made such that, in case the hollow rotary shaft 201 is disposed coaxially with the push member 14, the rotating force from the fine-adjustment mechanism 10 is transmitted only to the hollow rotary shaft 201. In this case, an actuator (not illustrated) to move the hollow rotary shaft 201 up and down may be added. In this manner, at the time of rotating the substrate S from the coarse-adjustment mechanism 100 through the push member 14, the chuck plate 11 is moved up by pushing only the push member 14. On the other hand, at the time of rotating the substrate S by the fine-adjustment mechanism 10 through the hollow rotary shaft 201, the chuck plate 11 is moved up by pushing only the hollow rotary shaft 201. In case there is added the actuator to move the hollow rotary shaft 201 up and down, the rotary shaft (push member) to which the rotating force is given from the fine-adjustment mechanism 10 need not be disposed coaxially with the rotary shaft (hollow rotary shaft) to which the rotating force is given from the coarse-adjustment mechanism 100.

In the above-mentioned embodiment and each of the modified examples, descriptions have so far been made of examples in which the stage 4, 30 equipped with an alignment function was applied to a coating apparatus. Without being limited thereto, this invention may be applied to a case in which, like a back-grinding step to be performed, e.g., in the steps of manufacturing semiconductor devices, a predetermined processing is performed by cutting tools (processing means) to a wafer (an object to be processed) from a side opposite to the wafer, the wafer being disposed on a stage arranged in a movable manner. In this manner, alignment of the object to be processed can be made relative to the cutting tool.

### BRIEF DESCRIPTION OF THE DRAWINGS

FIG. 1 is a schematic side view of an inkjet type of coating apparatus provided with a stage equipped with an alignment function according to an embodiment of this invention;

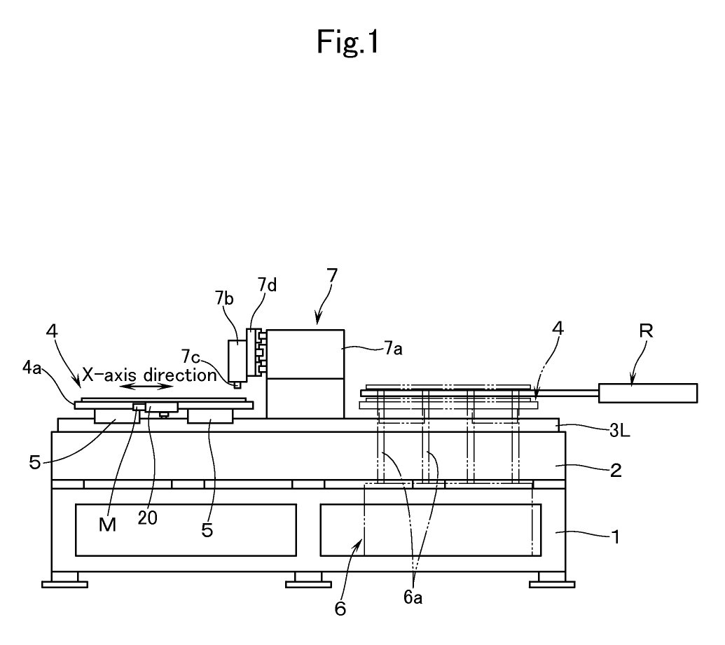

FIG. 2 is a partial plan view of the inkjet type of coating apparatus explaining the stage main body;

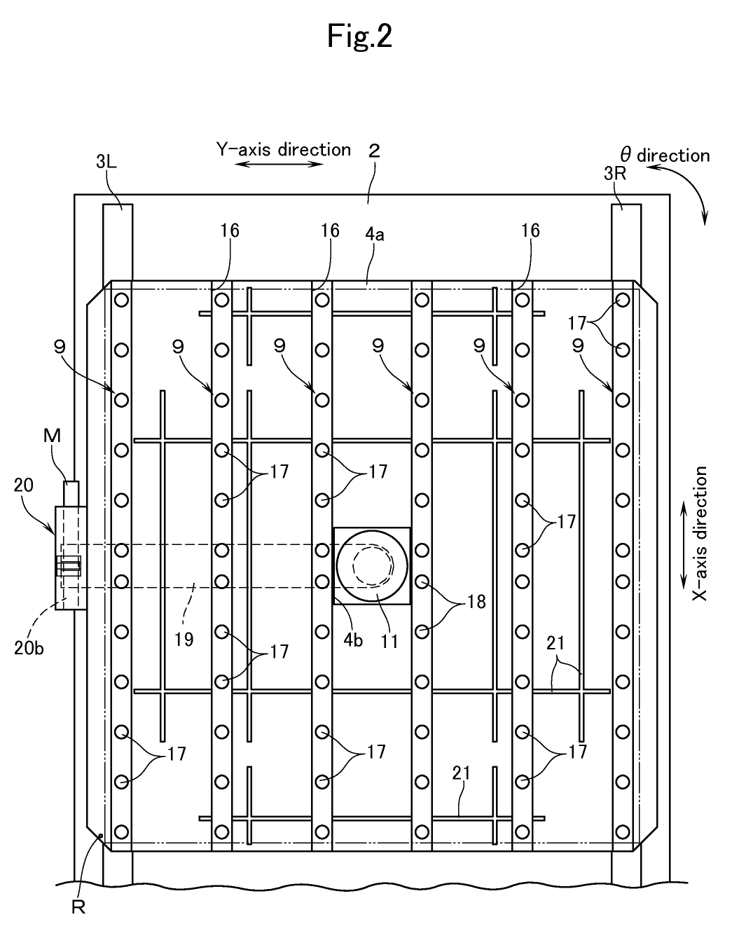

FIG. 3 is a partial sectional view of the inkjet type of coating apparatus explaining the arrangement of the stage main body;

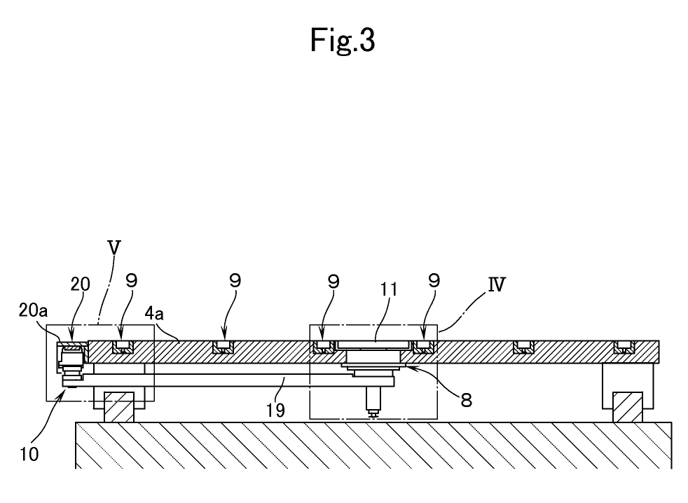

FIG. 4 is a partial sectional view showing an enlargement of the part IV in FIG. 3;

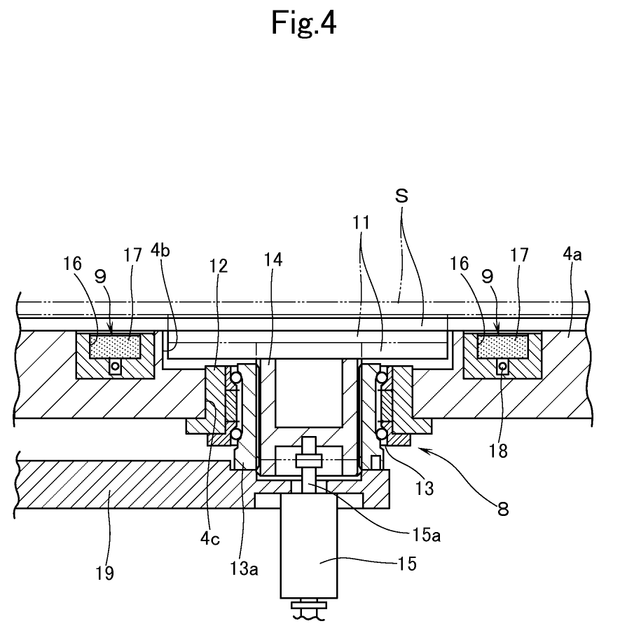

FIG. 5 is a partial sectional view showing an enlargement of the part V in FIG. 3;

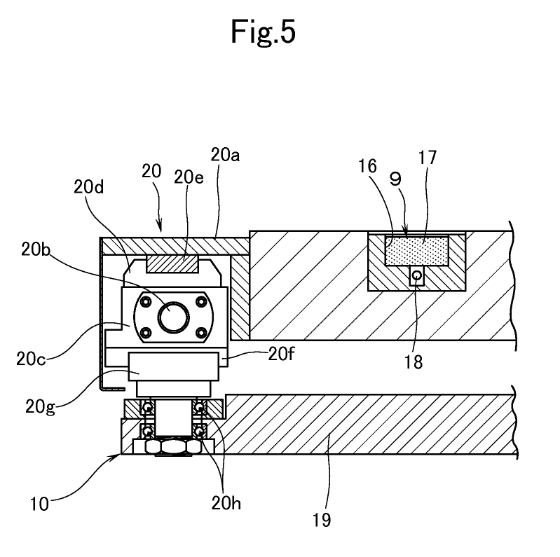

FIG. 6 is a schematic plan view explaining the alignment of the substrate in the θ direction by the stage according to this invention;

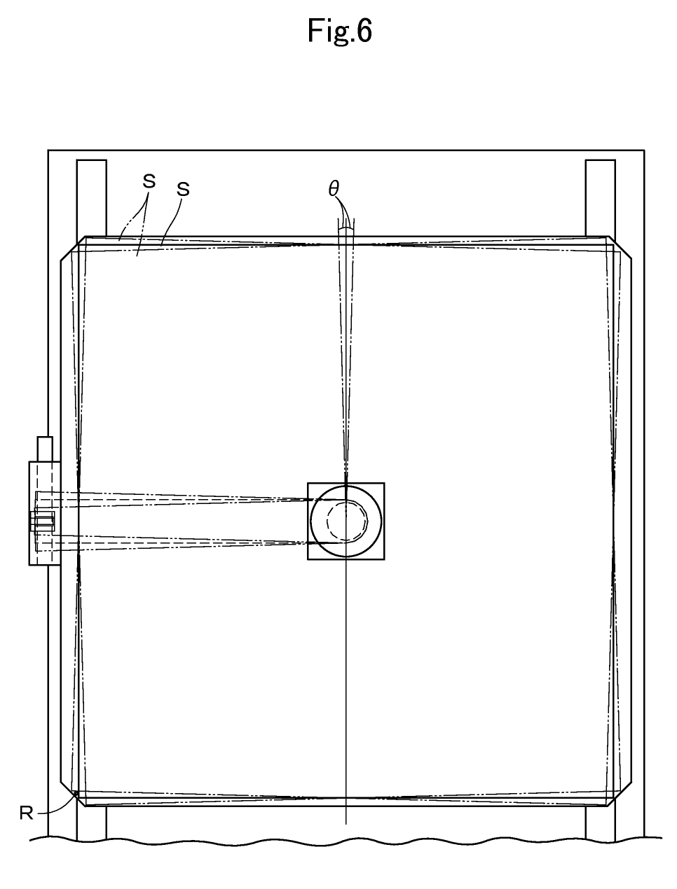

FIG. 7 is a schematic side view explaining a first modified example of the stage equipped with the alignment function according to this invention;

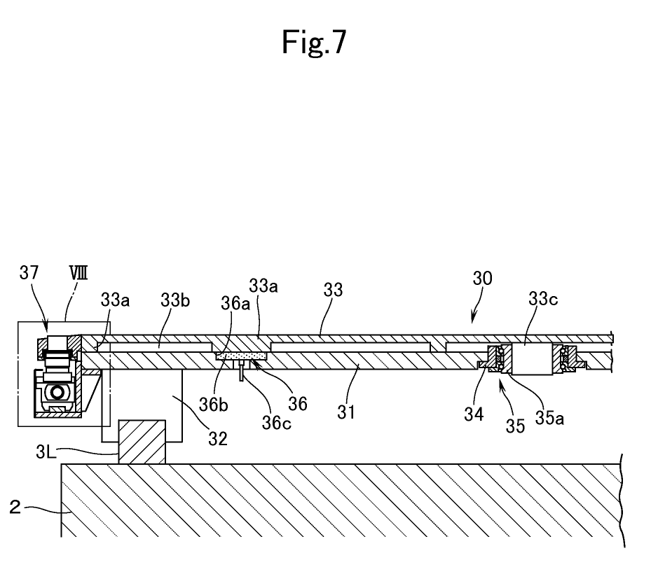

FIG. 8 is a partial sectional view showing an enlargement of part VIII in FIG. 7;

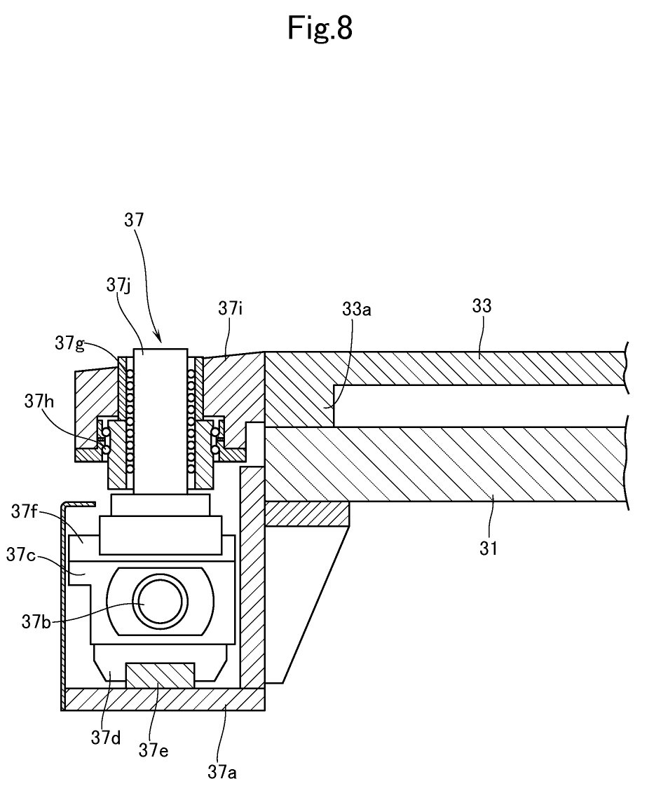

FIG. 9 is a plan view of the stage shown in FIG. 7;

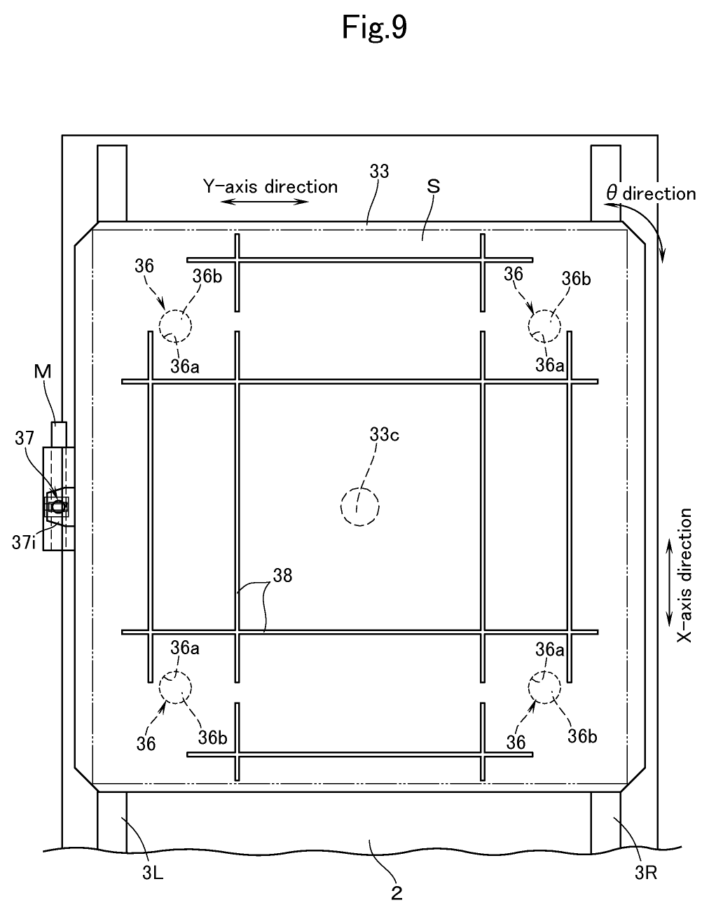

FIG. 10 is a partial sectional view explaining a second modified example of the stage equipped with the alignment function according to this invention;

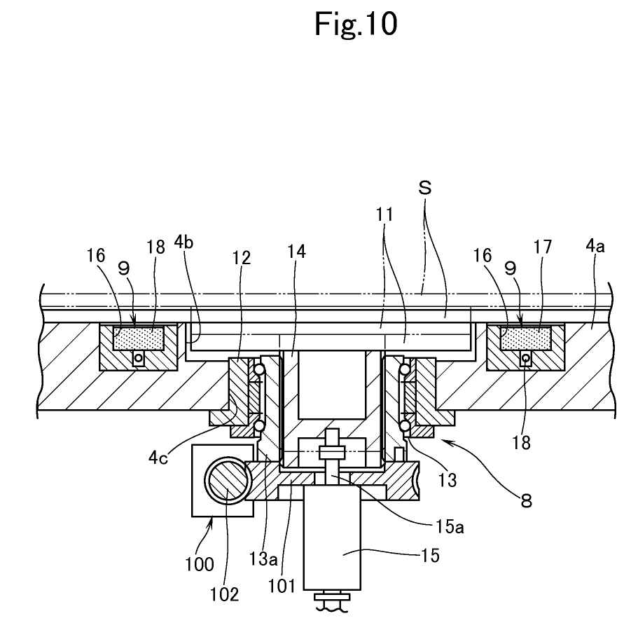

FIG. 11 is a partial sectional view explaining a third modified example of the stage equipped with the alignment function according to this invention

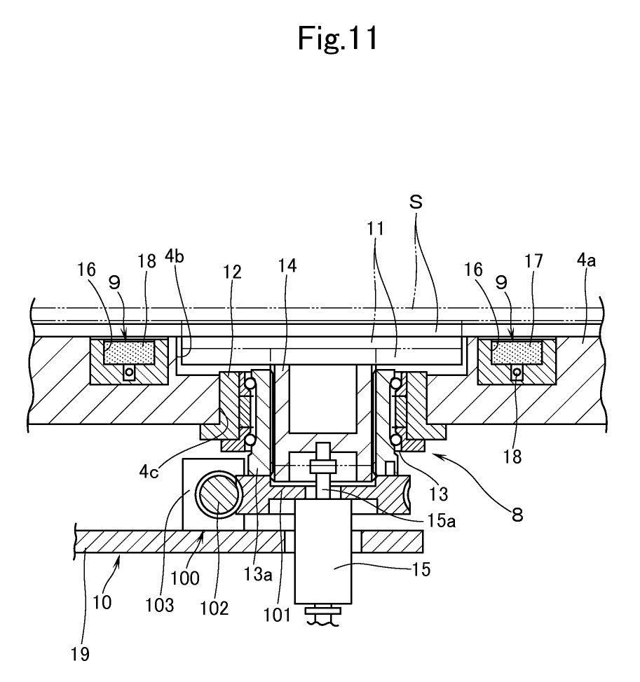

FIG. 12 is a perspective view explaining by partially enlarging a drive means of the stage equipped with the alignment function relating to a third modified example; and

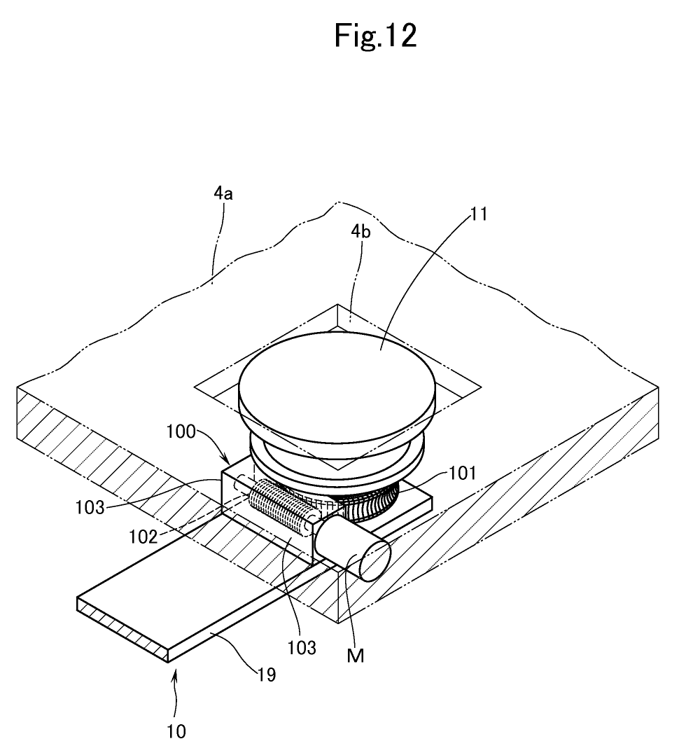

FIG. 13 is a partial sectional view explaining a fourth modified example of the stage equipped with the alignment function according to this invention.

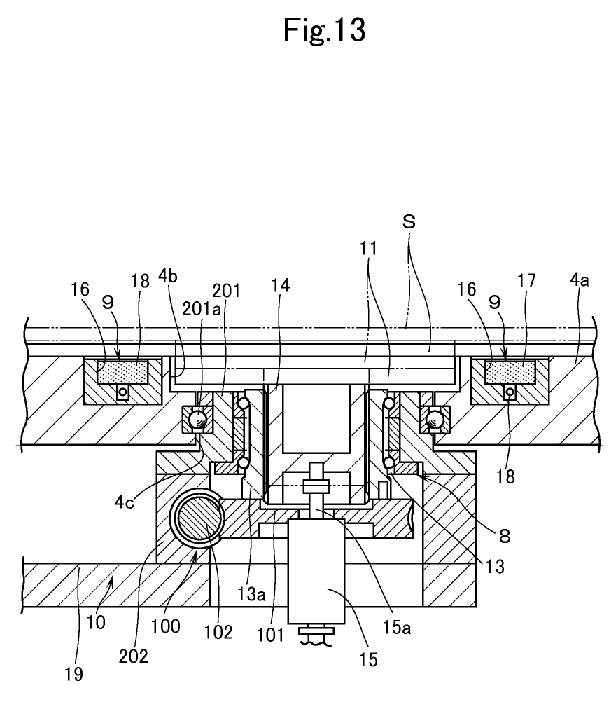

### DESCRIPTION OF REFERENCE NUMERALS AND CHARACTERS

1 3R, 3L rail member (guide means)
4, 30 stage
4a, 31 stage main body
8 suction means
9 gas supply means
10 fine-adjustment mechanism (drive means)
100 coarse-adjustment mechanism (drive means)
21 suction groove
33 holding tray
S substrate (object to be processed)

1. A stage equipped with an alignment function, the stage having a stage main body for holding an object to be processed while leaving a processing surface thereof open to access, the stage comprising:
a suction means capable of sucking an opposite surface of the object to be processed, the opposite surface lying counter to the processing surface;
a gas supply means for supplying a gas to such a region of the object to be processed as is other than a portion sucked by the suction means; and
a drive means for rotatably driving the suction means so as to rotate the object to be processed on a same plane by causing the suction means to serve as a center of rotation.

2. A stage equipped with an alignment function, the stage having a holding tray for holding thereon an object to be processed while leaving a processing surface thereof open to access, and a stage main body for supporting the holding tray in a rotatable manner, the stage comprising:
a gas supply means for supplying a gas to an opposite surface of the holding tray, the opposite surface lying counter to the processing surface; and
a drive means for rotatably driving the holding tray so as to rotate the holding tray on a same plane.

3. The stage equipped with an alignment function according to claim 1, further comprising a guide means, and a moving means for moving the stage main body along the guide means.

4. The stage equipped with an alignment function according to claim 1, further comprising:
a suction groove formed along a surface of contact of the stage main body or the holding tray with the object to be processed; and
a vacuum pump for evacuating the suction groove in a state in which the object to be processed is mounted on the stage or the holding tray.

5. The stage equipped with an alignment function according to claim 1, wherein the drive means comprises: a fine-adjustment mechanism for rotating the suction means within a predetermined micro-angle range; and a coarse-adjustment mechanism for rotating the suction means within an angle range larger than the angle range of the fine-adjustment mechanism.

6. The stage equipped with an alignment function according to claim 5, wherein the coarse-adjustment mechanism is coupled to the suction means, wherein the fine-adjustment mechanism comprises an arm and a drive source for swinging the arm, and wherein the fine-adjustment mechanism and the coarse-adjustment mechanism are operatively coupled to each other such that, when the arm is swung by the drive source, the suction means is rotatably driven through the coarse-adjustment mechanism.

7. The stage equipped with an alignment function according to claim 5, wherein the arm of the fine-adjustment mechanism has a length to be extended at least to one side of the stage main body and is connected at a front end of the arm to the drive source.

8. A processing apparatus comprising:
the stage equipped with an alignment function according to claim 1; and
a processing means for performing a predetermined processing on the object to be processed, the processing means being disposed to lie opposite to the object to be processed that is held by the stage.

9. A method of aligning an object to be processed comprising the steps of:
mounting on a stage the object to be processed in a manner to leave a processing surface thereof open to access;
causing a suction means to suck an opposite surface of the object to be processed, the opposite surface lying counter to the processing surface, the sucking means being disposed on the stage;
supplying a gas to the opposite surface except for a region that is sucked by the suction means; and
aligning the object to be processed by rotating the object to be processed by a predetermined angle on a same plane by causing the suction means to serve as a center of rotation.

10. The method of aligning an object to be processed according to claim 9, wherein the step of aligning the object to be processed comprises: rotating the suction means by a range of angle which is larger than a predetermined micro-angle range; and thereafter further rotating the suction means within the micro-angle range.

11. The stage equipped with an alignment function according to claim 2, further comprising a guide means, and a moving means for moving the stage main body along the guide means.

12. The stage equipped with an alignment function according to claim 2, further comprising:
a suction groove formed along a surface of contact of the stage main body or the holding tray with the object to be processed; and
a vacuum pump for evacuating the suction groove in a state in which the object to be processed is mounted on the stage or the holding tray.

13. The stage equipped with an alignment function according to claim 3, further comprising:
a suction groove formed along a surface of contact of the stage main body or the holding tray with the object to be processed; and
a vacuum pump for evacuating the suction groove in a state in which the object to be processed is mounted on the stage or the holding tray.

14. The stage equipped with an alignment function according to claim 2, wherein the drive means comprises: a fine-adjustment mechanism for rotating the suction means within a predetermined micro-angle range; and a coarse-adjustment mechanism for rotating the suction means within an angle range larger than the angle range of the fine-adjustment mechanism.

15. The stage equipped with an alignment function according to claim 3, wherein the drive means comprises: a fine-adjustment mechanism for rotating the suction means within a predetermined micro-angle range; and a coarse-adjustment mechanism for rotating the suction means within an angle range larger than the angle range of the fine-adjustment mechanism.

16. The stage equipped with an alignment function according to claim 11, wherein the drive means comprises: a fine-adjustment mechanism for rotating the suction means within a predetermined micro-angle range; and a coarse-adjustment mechanism for rotating the suction means within an angle range larger than the angle range of the fine-adjustment mechanism.

17. The stage equipped with an alignment function according to claim 14, wherein the arm of the fine-adjustment mechanism has a length to be extended at least to one side of the stage main body and is connected at a front end of the arm to the drive source.

18. The stage equipped with an alignment function according to claim 6, wherein the arm of the fine-adjustment mechanism has a length to be extended at least to one side of the stage main body and is connected at a front end of the arm to the drive source.

19. A processing apparatus comprising:
the stage equipped with an alignment function according to claim 2; and
a processing means for performing a predetermined processing on the object to be processed, the processing means being disposed to lie opposite to the object to be processed that is held by the stage.
